(19) United States
(12) Patent Application Publication
(10) Pub. No.: US 2020/0080032 A1
(43) Pub. Date: Mar. 12, 2020

(54) FLUIDIZED BED MALT ROASTER AND METHOD OF ROASTING MALTS

(71) Applicant: Aaron F. Goss, Statesville, NC (US)

(72) Inventor: Aaron F. Goss, Statesville, NC (US)

(21) Appl. No.: 16/568,337

(22) Filed: Sep. 12, 2019

Related U.S. Application Data
(60) Provisional application No. 62/730,243, filed on Sep. 12, 2018.

(51) Int. Cl. C12C 1/10; F26B 3/08

(52) U.S. Cl. CPC C12C 1/10; F26B 3/08

(57) ABSTRACT

A malt roaster that includes a roasting chamber having a perforated, air permeable plate enclosing a first end, and an outlet from the roasting chamber positioned on a second end remote from the first end a blower is provided for injecting heated air into the roasting chamber through the air permeable plate at a rate sufficient to fluidize and maintain in an air-suspended condition a predetermined quantity of malt positioned in the roasting chamber for roasting, and a heater is provided for controlling the temperature of the air stream being used to fluidize the malt bed and thereby kiln or roast the malt.

### TECHNICAL FIELD AND BACKGROUND OF THE INVENTION

The invention relates to an apparatus and method for roasting malts in preparation for their use in the production of beers and liquors. For the creation of certain beer styles and for imparting flavor to liquors, malts are commonly stewed and/or roasted as part of the malting process. Stewing involves increasing the temperature of the malt while maintaining high humidity in the air, while roasting involves increasing the temperature in the absence of moisture. After stewing, the malt may be further roasted or simply dried (kilned) using warm air. After stewing, roasting and/or kilning, the malt is cooled. The invention is designed to perform stewing, roasting, kilning, and cooling on malt.

Beer, malt liquor, and many spirituous liquors are made from malt, which is a product made from barley, wheat, oats, rye, or other cereal grains, legumes or pulses. Malt supplies two key ingredients for alcohol formation: starch and amylase enzymes that break down the starch into sugar. It also supplies much of the flavor and body of beer.

For many beer styles and for adding body and head retention to all beers, special malts are created by stewing and roasting malts during processing. Traditionally, these processes have been performed in a heated drum with a mixing apparatus inside to homogenize the roasting malt batch and prevent prolonged contact between any one kernel and the hot drum wall. The drum method involves several undesirable elements which are improved on by the invention herein disclosed: burning of malt kernels creating bitter and potentially carcinogenic compounds, large thermal mass making fast temperature changes difficult, long roasting time due to inefficient heat transfer and high cost of construction. As explained in greater detail below, the present invention allows malt to be stewed, roasted, kilned, and cooled in a fluidized bed, which relative to the drum style of roaster improves the efficiency of heat transfer to the individual malt kernels, reduces roasting time, improves the homogeneity of the batch and reduces undesirable burning of individual kernels against the wall of a drum roaster. The present invention also requires fewer moving parts than the drum roaster and less overall material, making it simpler and less material-intensive to build.

### SUMMARY OF THE INVENTION

A fluidized bed malt roaster is disclosed that provides for stewing, roasting, kilning, and cooling of malt in a highly controlled manner. The primary processing area of the roaster is a roasting chamber, consisting of a cylindrical chamber with an air-permeable floor which is supported in the chamber and which during use supports a volume of malt. Below the air-permeable floor is an air inlet formed so as to introduce a stream of air into the chamber through the air-permeable floor. The stream of air passes through and fluidizes the malt, exerting drag forces on each kernel such that the force of gravity is counteracted and the kernels can move about freely. At the top of the chamber is an air outlet that directs the stream of air out of the chamber after it has passed through the malt.

A blower is ducted to the air inlet, operable to provide the fluidizing stream of air. Also ducted in series with the blower is a heater, which may produce heat via any common method: burning fuel or electrical resistance for example. Generally, the heater will transfer heat into the air stream via a heat exchanger so as to isolate the byproducts of combustion from the air stream, but in the case of an electric heating element or in the case of wood fuel where it is desired to produce a smoked flavor in the malt, direct heating of the air may be used. One or more misting nozzles or sprayers sufficient to fully humidify the inlet air stream are positioned downstream of the blower and heater in the duct. A temperature sensor is positioned in the duct downstream of the heater and so as to sense the temperature of the stream of air and adjust the intensity of the heater to reach the desired temperature.

The roaster may be operated via manual control or by an automated control system, which may include automatic adjustment of the intensity of the heater, blower, control of the misting system, based on input from various sensors, possibly using various controllers such as PID, thermostats, and various other industrial temperature and humidity controls to turn the blower, mister and heater on and off and adjust their intensity, and to operate the various dampers described below.

The roaster also includes ductwork and dampers, described more fully in FIG. 1 and associated descriptive text below, to enable the intake of air from an external source and exhaust back thereto, or for recirculation of air through the fluidized bed, and to control the amount of intake versus recirculated air. By operation of these dampers and ducts, the roaster can make more efficient use of heating fuel by recirculating air so as to retain heat in the air stream, or cool the malt bed by taking in relatively cool air from its environment. The roaster may be embodied in one or more variations that include the key elements of a fluidized bed roasting chamber, blower, heater and possibly a mister.

Further disclosed are methods for stewing, roasting, kilning, and cooling malt in the fluidized bed malt roaster.

### BRIEF DESCRIPTION OF THE DRAWING

FIG. 1 is a schematic view of one embodiment of the fluidized bed malt roaster.

### DETAILED DESCRIPTION OF THE INVENTION

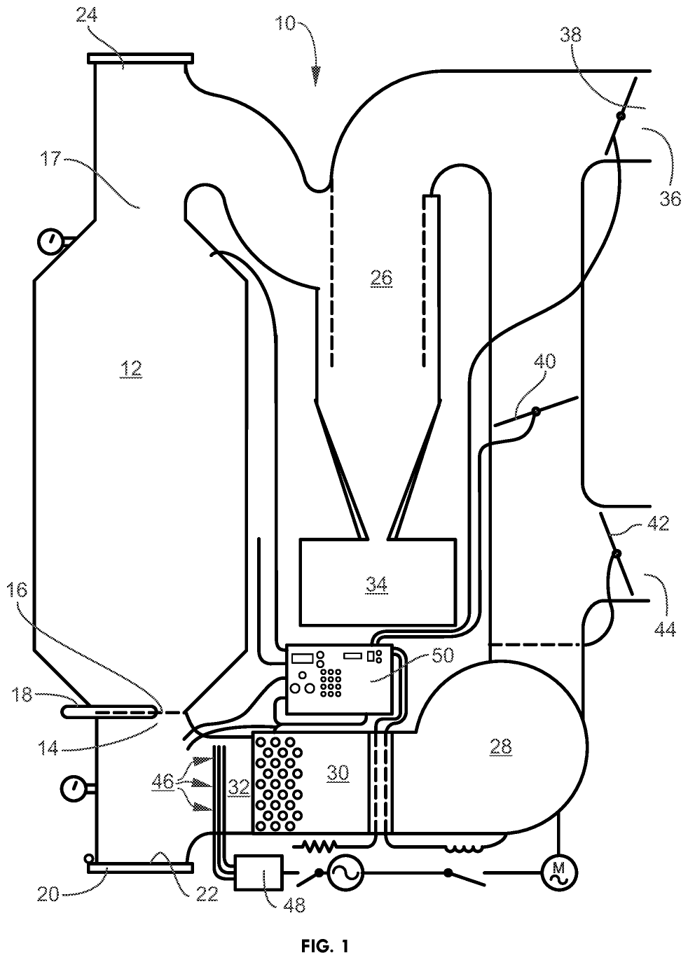

Referring now to FIG. 1, a fluidized bed malt roaster is shown and broadly indicated at reference numeral 10. The roaster 10 allows precise control of the time-temperature profile of stewing, roasting, kilning, or cooling malt. The present invention may be implemented in a number of different embodiments including fully automated, fluidized bed roasting systems as well as in roasting systems which are under at least partial manual control.

The roaster 10 includes a roasting chamber 12 which retains the malt during the stewing, roasting, kilning, or cooling process and an air inlet 14 for introducing a stream of air into the chamber 12 and an air outlet 17 for permitting the air stream to exit. The perforated plate 16 at the air inlet 14 is permeable to the airstream and supports the malt during processing.

The perforated plate 16 is hinged and connected to a lever 18 which is further connected to a bottom closure member 20 which seals a malt outlet 22 of the roasting chamber 12. The chamber 12 also includes a fill cap 24 which opens and closes with a seal and is used for loading the chamber 12. In a specific embodiment, all or part of the cylindrical wall portion of the roasting chamber 12 may be fabricated from a transparent material, such as a high temperature glass or polymer, so as to permit viewing of the malt during processing.

The air outlet 17 is connected via ductwork to, for example, a cyclone 26 or other device which captures any matter that may be entrained and blown upward from the malt bed, so as to prevent said matter from damaging or fouling the blower 28, heater 30, or mister 32, or from polluting the roaster's environment. Any matter captured by the cyclone 26 falls into the collection drum 34 for removal and discarding.

The outlet of the cyclone 26 is connected via ductwork to the exhaust port 36, which is opened and closed by the exhaust damper 38. The exhaust damper 38 is operated in conjunction with the recirculation damper 40 and the intake damper 42 to ensure a supply of air to the blower 28 and to control how much of the air is brought in from the environment versus recirculated through the malt bed. As illustrated, the ductwork includes a tee fitting upstream of the exhaust damper 38 to allow air to flow either through the recirculation duct path or out the exhaust port 38. Another tee fitting is positioned downstream of the recirculation damper 40 and the intake damper 42 to allow intake air to the blower 28 to come from either the recirculation duct path or the intake port 44. The intake port 44 is opened or closed by the intake damper 42

The blower 28 provides the pressurized stream of air that enters the fluidization chamber 12 via the inlet 14 and exerts sufficient drag force on the malt therein to balance the downward force of gravity. The blower 28 can either intake environmental air via the intake port 44 if the intake damper 42 is open, or if the intake damper 42 is closed and the recirculation damper 40 is open, it can intake recirculated air from the fluidization chamber 12, or if the dampers are partially open or closed it can intake a mix of recirculated or fresh air.

The heater 30 heats the air stream to a desired temperature as determined by the operator. The set point temperature is detected by a temperature sensor inserted into the duct downstream of the heater. The heater may be fueled by combustion of gases or other fuels, or by electrical resistance heating, or by other method of generating heat. If fueled by combustion, the heat should be transferred into the air stream by indirect method such as a heat exchanger, but if the heating method does not generate byproducts (as with electrical resistance heating) or if the byproducts are desired to flavor the malt (as with wood smoke), the heat may be applied directly to the air stream.

The roaster 10 optionally includes a humidification system also as shown in FIG. 1. A set of misting nozzles 46 with orifices of sufficient size to humidify the air stream are supplied with filtered water from a high-pressure pump 48 which is controlled via a solenoid and electrical relay. It is understood that other embodiments may not include a humidification system. The roaster 10 optionally includes an electronic control system 50 that includes sensors that feed data to the control system 50 which uses electrical signals to control the blower 28, heater 30, mister 32, and dampers 38, 40 and 42, and possibly other elements.

To operate the roaster 10, a load of malt is placed into the fluidization chamber 12 through the fill cap 24. The roaster 10 is activated via a main on-off switch which is part of the controller 50. The controller activates the blower 28 to provide a stream of air which is directed into the fluidization chamber 12. Once the air is flowing at a sufficient velocity and pressure for fluidization, the controller 50 activates the heater 30 to begin providing heated air to the chamber 12. The temperature of the air stream may be controlled by manual adjustment of the heater 30 via manual setting of a set point on an automated controller, or automatically according to a set schedule. The heater's intensity is adjusted and it is turned off and on in order to maintain the desired temperature. Fluidization takes place as the weight of the grain is balanced by the upward force of the heated air entering the chamber 12 from the bottom, suspending the grain in the moving airstream.

If it is desired to stew the malt prior to roasting or kilning, which is done in order to create “crystal” malts for example by activating amylase enzymes to create sugars, or to break down proteins via activation of protease enzymes, humidification of the air stream will often be desired, and may be achieved by activation of the mister 32. While air is flowing through the system, the mister 32 may be manually turned on and off, or it may be turned on and off via electronic signal from the control system 50.

After stewing, kilning or roasting is then accomplished by controlling the temperature of the air stream by adjusting the intensity of the heater 30 and turning it on and off to maintain set temperatures. The main purpose of kilning is drying the malt, which is done generally at temperatures up to 220° F., whereas roasting is done to produce more complex flavors and may occur at temperatures up to 450° F. or higher.

When the roasting or kilning is complete, the heater 30 is deactivated and fresh unheated air is then blown through the malt to cool it. Water may optionally be injected into the unheated air stream through the mister 32 if desired to further cool the air stream and hasten the cooling of the malt. The unheated air passes through the malt in the fluidization chamber 12 and exits through the outlet 16 thereof and is then exhausted via outlet 36

After cooling is completed, the hinged, air-permeable plate 16 is opened to allow the roasted malt to exit the chamber 12 through the malt outlet 22 which directs the malt to a bagging apparatus. The basic invention may include other refinements. For example, the system might include a variety of safety devices. An embodiment might include an over temperature sensor to detect an emergency situation resultant from a fire in the roasting chamber or other malfunction. The over temperature sensor could be wired to cut power to the heater and blower, and possibly to open a solenoid that would flood the fluidization chamber with water from a main water line.

In view of the foregoing, it will be appreciated that the invention be practiced in a variety of configurations. For example, the principles hereof may be used at various scales in order to roast smaller or larger batches of malt at once. While the invention has been described with particular regard to a malt roaster, it is to be understood that the present invention may be practiced in conjunction with other types of food product roasters such as nut roasters. Therefore, it is to be understood that the foregoing drawings, discussion, and description are merely meant to illustrate particular embodiments of the invention, and are not meant to be limitations upon the practice thereof. It is the following claims, including all equivalents, which define the scope of the invention.

What is claimed is:

1. A malt roaster, comprising:
(a) a roasting chamber having a perforated, air permeable plate enclosing a first end, and an outlet from the roasting chamber positioned on a second end remote from the first end;
(b) a blower for injecting heated air into the roasting chamber through the air permeable plate at a rate sufficient to fluidize and maintain in an air-suspended condition a predetermined quantity of malt positioned in the roasting chamber for roasting; and
(c) a heater for heating and controlling the temperature of the air stream being used to fluidize the malt bed and thereby kiln or roast it.
